(19) United States
(12) Patent Application Publication
(10) Pub. No.: US 2004/0065184 A1
(43) Pub. Date: Apr. 8, 2004

(54) Music box

(76) Inventors: Akihiko Isaka, Nagano (JP); Makoto Nagai, Tokyo (JP)

Correspondence Address: Eugene LeDonne, Reed Smith, 29th Floor, 599 Lexington Avenue, New York, NY, 10022, US

(21) Appl. No.: 10/466,925

(22) PCT Filed: Jan. 22, 2001
(86) PCT No.: PCT/JP01/00379

(51) Int. Cl. G10F 1/06

(52) U.S. Cl. 84/94.1

(57) ABSTRACT

There is provided a music box of great volume and excellent sound quality. A box is formed of a sounding board for transferring a sound produced by a movement of a music box, three columns for supporting the sounding board, a bottom plate, side plates, and supplementary wood pieces. Spacers are disposed between a base frame of the movement and the sounding board and leg portions are disposed at a lower face of the bottom plate and are integrally fixed to the columns by screw bodies. Spaces formed by the spacers and the leg portions function effectively for transmitting the sound.

### FIELD OF THE INVENTION

The present invention relates to a music box and particularly to a structure of a device for expanding sound volume and improving sound quality

### BACKGROUND OF THE INVENTION

Movements of music boxes are known and are broadly divided into a disc type and a cylinder type. The movement of each type is normally housed in a wooden box. A sound produced by a vibrating plate itself of the music box is faint and propagation of a sound by the wooden box in which a sound producing mechanism is mounted cannot allow a subtle tone of the music box to sufficiently sound. Therefore, according to a music box disclosed in Japanese Utility Model Registration No. 3068225, a music box is devised. This music box is formed of a box 1, a resonance board 6 to be resonated by a sound of a music box, and the music box 5. The resonance board 6 and the box 1 form a sounding space 7, an opening 9 through which the sound of the music box is emitted outside is formed at a portion of a bottom plate 8 of the sounding space 7, and volume of the sound of the music box is expanded by the box 1, the resonance board 6, and the opening 9.

However, in a method in which vibration of the music box 5 is transferred to the resonance board 6, air inside the sounding space 7 is vibrated by vibration of the resonance board 6, and the vibration of the air is emitted through the opening 9, a size of the resonance board 6 needs to be increased so as to obtain the sound volume in middle and lower registers. Furthermore, the vibrations of the music box 5 and the resonance board 6 are less liable to be transferred to the box 1 or the bottom plate 8. As a result, the vibrations are damped and transferred to a table (e.g. a desk) on which the box 1 is placed and therefore, transmission efficiency in vibration energy is not satisfactory.

Therefore, it is an object of the present invention to resonate musical sounds played by the music box over a low to high wide range of frequencies, to efficiently expand volume of the sounds, and to transfer them.

### SUMMARY OF THE INVENTION

To achieve the above object, according to the present invention, there is provided a music box, wherein a box is formed of a plurality of side plates, a sounding board mounted in vicinities of upper ends of the side plates, a bottom plate mounted in vicinities of lower ends of the side plates, and at least three columns sandwiched between the sounding board and the bottom plate. A sound producing body base frame is mounted on the sounding board of the box and fixed to the columns integrally with the sounding board by coupling members at three or more positions through a spacer of a proper height. Leg portions of proper heights and bottom areas are disposed in positions of a lower face of the bottom plate corresponding to portions where the columns are extending and are integrally fixed with the bottom plate to the columns by coupling members passing through the bottom plate.

By providing the spacers between the music box and the sounding board and integrally fixing the sounding board and the columns by the coupling members as described above, vibration of the sound producing body can be reliably transferred to the sounding board and the columns. Because a clearance is ensured by the spacers between the sound producing body and the sounding board, the vibration of the sound producing body base frame enhances contact pressure (stress) between the sound producing body base frame and the sounding board, and vibrating efficiency can be further increased.

Furthermore, by disposing the leg portions at the bottom plate and integrally fixing the leg portions to the columns by the coupling members, the vibration of the sounding board is transferred to the bottom plate and also the vibration of the bottom plate itself is not hindered. Therefore, the vibration is reliably and efficiently transferred to a table (e.g. a desk) on which the box is placed through the leg portions.

The sound producing body may be a movement of a cylinder-type music box or a movement of a disc-type music box. The box is made of a close-grained wood. Furthermore, material which produces nice sound effects (e.g., spruce and the like) is used for the sounding board. The columns function as members for applying internal stress to the sounding board.

Headed screw bodies are used as the coupling members, positions of the sound producing body base frame where the frame is to be fixed by the coupling members are aligned with positions of the columns, the screw bodies are screwed into the columns, and the sound producing body base frame, the spacer, and the sounding board are fixed while being integrally sandwiched between head portions of the screw bodies and the columns.

### BRIEF DESCRIPTION OF THE DRAWINGS

FIGS. 1(a) to 1(c) show a first embodiment of a music box according to the present invention. FIG. 1(a) is a plan view, FIG. 1(b) is a side view taken along a line B-B in FIG. 1(a), and FIG. 1(c) is a side view taken along a line CC in FIG. 1(a).

FIGS. 2(a) to 2(c) show a second embodiment of the music box according to the invention. FIG. 2(a) is a plan view, FIG. 2(b) is a side view taken along a line B-B in FIG. 2(a), and FIG. 2(c) is a side view taken along a line C-C in FIG. 2(a).

FIGS. 3(a) to 3(c) show a third embodiment of the music box according to the invention. FIG. 3(a) is a plan view, FIG. 3(b) is a side view taken along a line B-B in FIG. 3(a), and FIG. 3(c) is a side view taken along a line C-C in FIG. 3(a).

FIGS. 4(a) to 4(c) show a fourth embodiment of the music box according to the invention. FIG. 4(a) is a plan view, FIG. 4(b) is a side view taken along a line B-B in FIG. 4(a), and FIG. 4(c) is a side view taken along a line C-C in FIG. 4(a).

FIG. 5 is a perspective view of a fifth embodiment of the invention.

FIG. 6 is a perspective view of a music box shown in FIG. 5 with a lid open.

FIG. 7 is a sectional view taken along a line III-III in FIG. 6.

### DETAILED DESCRIPTION OF THE INVENTION

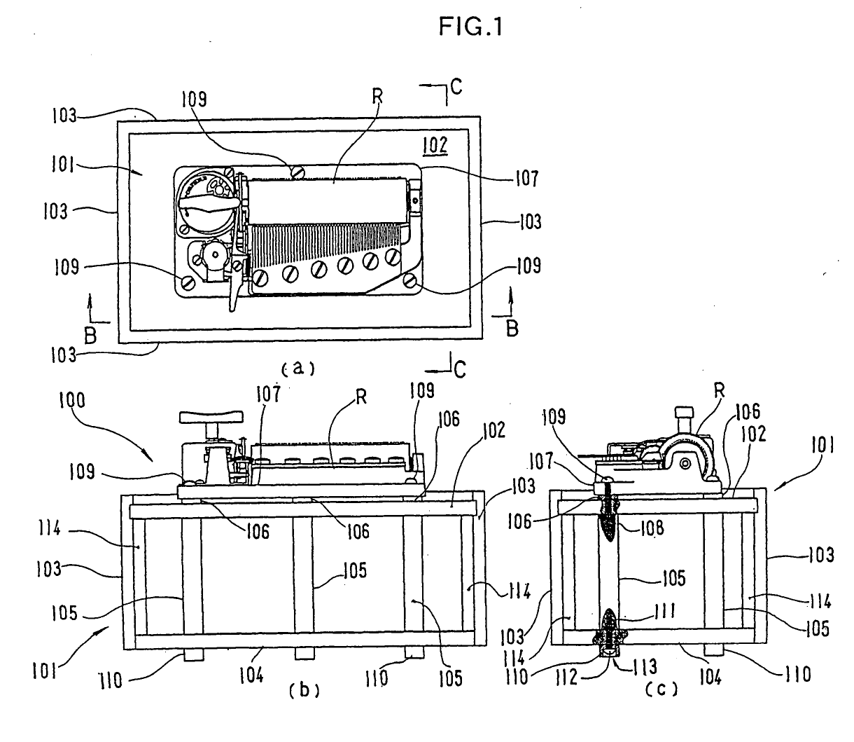

Embodiments of a music box according to the present invention will be described below based on the drawings. FIGS. 1(a) to 1(c) show a music box 100 which is a first embodiment of a music box according to the invention and on which a movement R of a cylinder-type music box is placed. FIG. 1(a) is a plan view, FIG. 1(b) is a side view taken along a line B-B in FIG. 1(a), and FIG. 1(c) is a side view taken along a line C-C in FIG. 1(a).

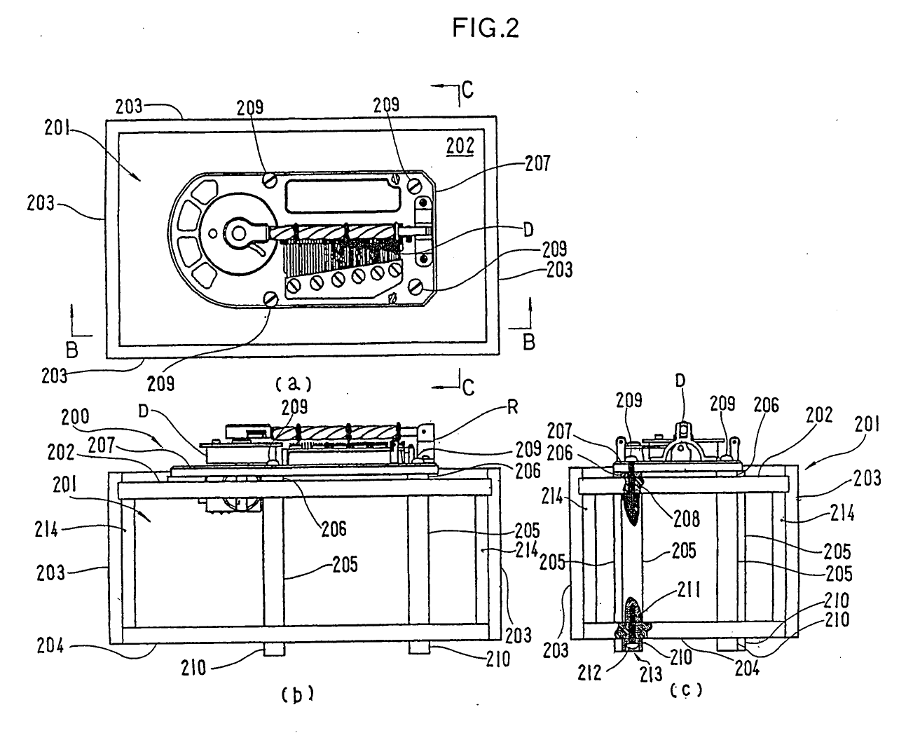

FIGS. 2 to 4 show music boxes 200 to 400 of second to fourth embodiments on each of which a movement D of a disc-type music box is placed. In each drawing, only the movement with a disc detached is shown in the disc-type music box. Needless to say, on a structure of each of the second to fourth embodiments, the movement R of the cylinder-type music box can be placed instead of the movement D of the disc-shaped music box.

Because functions and operations of the movement R of the cylinder-type music box and the movement D of the disc-shaped music box are known, descriptions of them will be omitted. In FIGS. 1(a) to 1(c), a box 101 is formed of an upper horizontal sounding board 102, four side plates 103 surrounding four sides, and a lower bottom plate 104. For respective members forming the box 101, close-grained woods used for musical instruments such that sounds reverberate satisfactorily are suitable. Especially for the sounding board 102, material which produces nice sound effects, e.g. spruce or the like is used. If an outer face is coated with a coating, shellac varnish is selected as the coating.

Edge portions of the four sides of the sounding board 102 are supported by being fitted in grooves extending in vicinities of and along upper ends of inner faces of the side plates 103. Although the sounding board shown in the drawings has a uniform thickness, it is also possible that the thickness increases from the edge portions toward a center on a lower face of the sounding board 102 for the sake of sound effects. In joining the four side plates 103, a method such as splicing is employed, for example, without using nails and an adhesive.

On the lower face of the sounding board 102, three columns 105 are fixed in spaced positions so as not to be aligned with each other and these columns 105 also form a part of the box 101. In other words, headed screw bodies 108, e.g. bolts or wood screws pass through a base frame 107 of the movement R of the music box and the sounding board 102 in three positions to face the columns 105 to thereby integrally fasten and fix the base frame 107 and the sounding board 102 together with spacers 106 provided between the base frame 107 and the sounding board 102 and the spacers 106 are sandwiched between screw body head portions 109 and the columns 105.

The bottom plate 104 is connected to lower end portions of the side plates 103 by headed screw bodies, e.g. bolts or wood screws (not shown). At a lower face of the bottom plate 104, leg portions 110 having proper heights and bottom areas are disposed in positions corresponding to portions where the columns 105 are extending. Headed screw bodies 111, e.g. bolts or wood screws extend upward through the leg portions 110 and the bottom plate 104 and are screwed into the columns 105 to thereby integrally couple and fix the leg portions 110 and the bottom plate 104 between the columns 105 and screw body head portions 112. In a lower face of each the leg portion 110, a countersunk hole 113 in which the head portion 112 of the screw body 111 is sunk is formed.

To fasten the side plates 103 and the bottom plate 104 together, slim supplementary wood pieces 114 are used. The supplementary wood pieces 114 are secured to an inside of a frame formed of the four side plates 103 by screw bodies (not shown) and form parts of the side plates 103. Upper ends of the supplementary wood pieces 114 can be positioned to be in contact with the lower face of the sounding board 102, i.e. to be in the same plane with lower faces of the grooves in the side plates 103.

In lower ends of the supplementary wood pieces 114, screw holes are formed in a vertical direction. The bottom plate 104 is formed to be neatly fitted inside the frame formed of the side plates 103. Coupling screw bodies (not shown) extending upward through the bottom plate 104 are screwed into the screw holes of the supplementary wood pieces 114 to thereby mount the bottom plate 104 to the lower end portions of the side plates 103.

A vertical length of each the supplementary wood piece 114 is slightly greater than a vertical length of each the column 105 and the lower ends of the supplementary wood pieces 114 are positioned in slightly lower positions than lower ends of the columns 105. Here, if the screw bodies 111 at the lower end portions of the columns 105 are tightened, the columns 105 stretch the sounding board 102 and the bottom plate 104 whose peripheral edges are supported on the supplementary wood pieces 114 to apply internal stress.

If the screw bodies 108 and 111 are further tightened, the movement R of the music box, the sounding board 102, the side plates 103, the bottom plate 104, and the columns 105 are integrated and coupled together tightly to be brought into a state highly advantageous to obtain satisfactorily reverberating sounds. Because of the box 101 which is compact but functions as a sounding box, low-pitched sounds reverberate sufficiently.

Next, a function of the music box according to the invention will be described. If the base frame 107 vibrates due to playing of the movement R of the music box, the vibration is transferred to the sounding board 102 through the spacers 106. At this time, because the base frame 107 and the sounding board 102 are in contact with each other only at positions of the spacers 106, vibrations of the sounding board 102 and the base frame 107 do not interfere with each other. The vibration of the sounding board 102 is reliably transferred to the bottom plate 104 through the supplementary wood pieces 114 and the columns 105.

The vibration of the bottom plate 104 is transferred to a mount (not shown) through the leg portions 110. Because the leg portions 110 provide a space between the bottom plate 104 and the mount, the vibration of the bottom plate 104 propagates outside through this space as an aerial vibration. Moreover, the leg portions 110 reduce contact areas between the mount and themselves to increase contact stress to thereby further reliably and efficiently transfer the vibration.

FIGS. 2(a) to 2(c) show a music box 200 according to a second embodiment in which a movement D of a disc-type music box is placed. FIG. 2(a) is a plan view, FIG. 2(b) is a side view taken along a line B-B in FIG. 2(a), and FIG. 2(c) is a side view taken along a line C-C in FIG. 2(a). In the drawings, members similar to those of the first embodiment are provided with three-digit reference numerals each including common last two digits and the first digit “2” so as to make a distinction between the members of the present embodiment and the first embodiment. In the second embodiment, an embodiment of a base frame 207 including four fixed positions 209 is shown. In other words, the present embodiment has a similar structure to the first embodiment except that the numbers of columns 205 and leg portions 210 are “four” according to the numbers of the fixed positions and therefore, the description will be omitted.

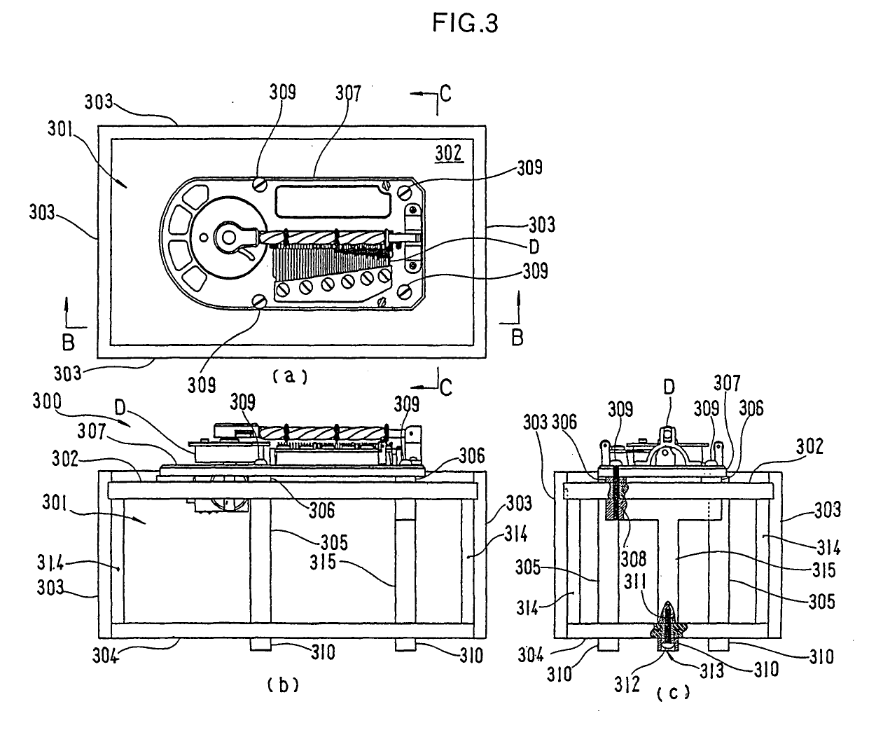

FIGS. 3(a) to 3(c) show a music box 300 of a third embodiment in which the movement D of the disc-type music box is placed. FIG. 3(a) is a plan view, FIG. 3(b) is a side view taken along a line B-B in FIG. 3(a), and FIG. 3(c) is a side view taken along a line C-C in FIG. 3(a). In the drawings, members similar to those of the first embodiment are provided with three-digit reference numerals each including common last two digits and the first digit “3” so as to make a distinction between the members of the present embodiment and other embodiments. In the third embodiment, an embodiment of a base frame 307 including four fixed positions 309 is shown. However, by forming one column 315 out of the columns 305 into a T shape, two fixed positions are supported on a T-shaped horizontal beam and the columns substantially result in a tree-column structure in spite of the four fixed positions of the base frame 307. Therefore, leg portions 310 are also disposed at three positions. Because other structures are similar to those of the first embodiment, description of them will be omitted.

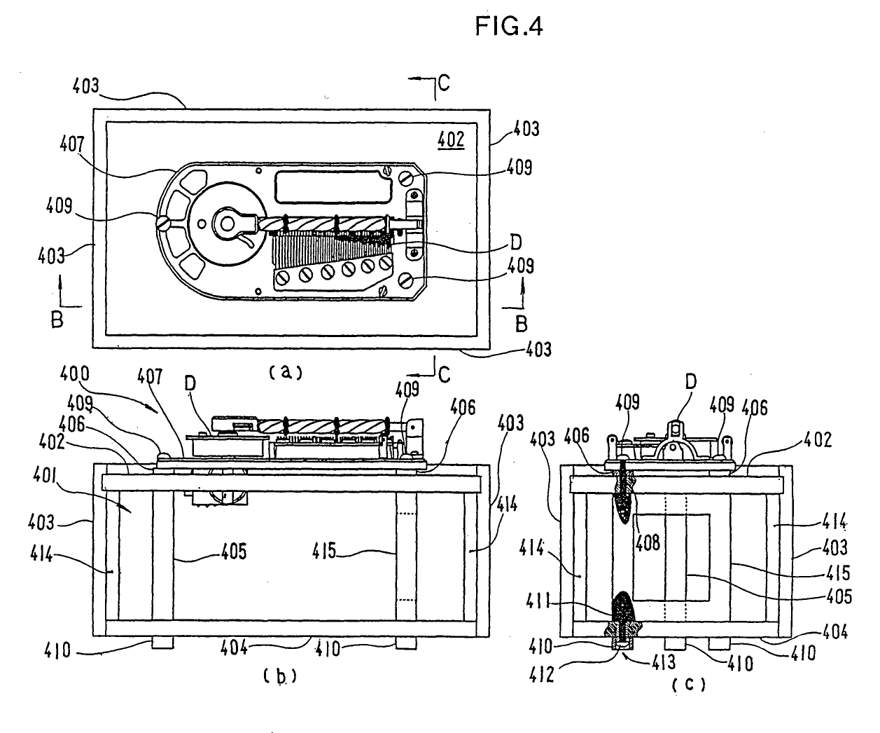

FIGS. 4(a) to 4(c) show a music box 400 of a fourth embodiment in which the movement D of the disc-type music box is placed. FIG. 4(a) is a plan view, FIG. 4(b) is a side view taken along a line B-B in FIG. 4(a), and FIG. 4(c) is a side view taken along a line C-C in FIG. 4(a). In the drawings, members similar to those of the first embodiment are provided with three-digit reference numerals each including common last two digits and the first digit “4” so as to make a distinction between the members of the present embodiment and other embodiments. In the fourth embodiment, an embodiment of a base frame 407 having three fixed positions 409 is shown. However, the fourth embodiment is a variation in which upper and lower portions of two columns out of three columns 405 are connected through two horizontal beams to be a rectangular frame-shaped column 415 and three leg portions 410 are provided. Because other structures are similar to those of the first embodiment, description of them will be omitted.

In the invention, heights of side plates and support plates of the box are preferably set such that the support plates receive compressive forces between the sounding board and the bottom plate. It is preferable that the box further includes a lid formed of double doors rotatably mounted to an upper end portion of the box. The lid covers the sounding board and a sound producing mechanism in a closed state and substantially the whole lid is in a lower position than the sound producing mechanism in an open state.

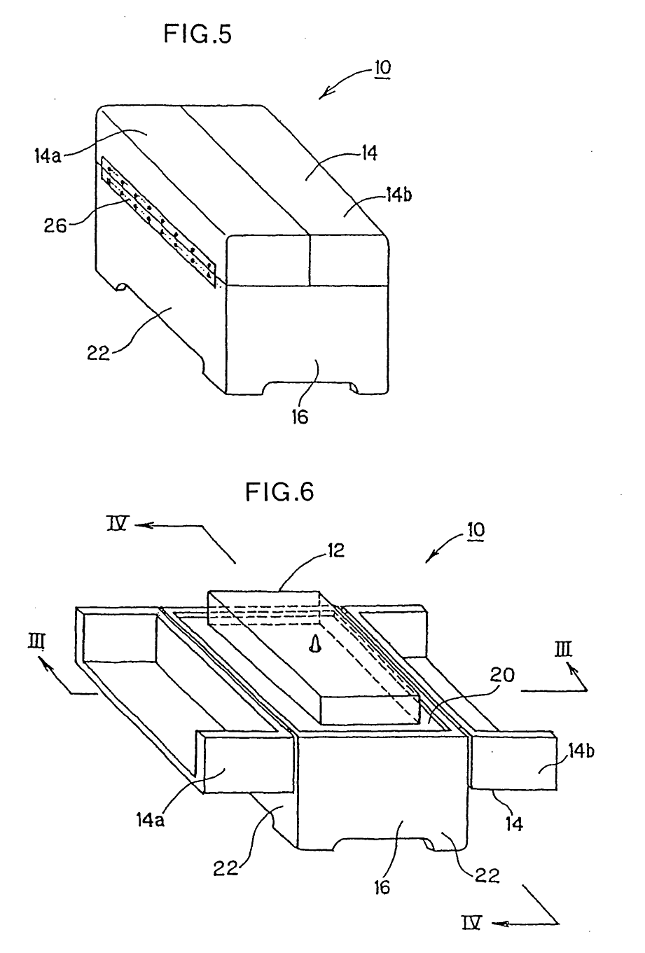

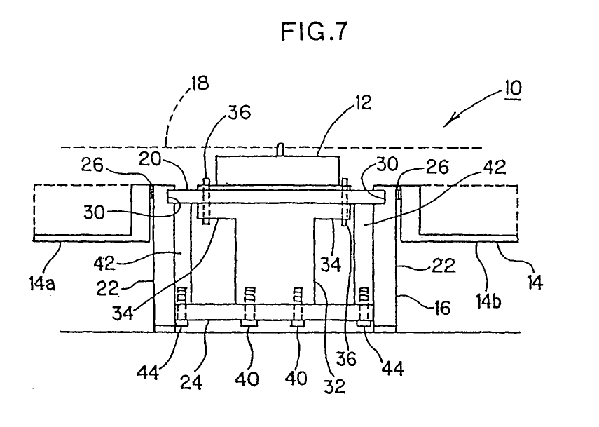

FIGS. 5 and 6 show a fifth embodiment of the invention. In these drawings, a music box 10 includes a sound producing mechanism 12 and a box 16 having a lid 14 and mounted with and housing the sound producing mechanism 12. The music box disc 18 (see a broken line in FIG. 7) can be detachably mounted to the sound producing mechanism 12 and the sound producing mechanism 12 has a comb-shaped member (not shown) to be engaged with a plurality of projections (not shown) provided to a lower face of the disc 18 to produce a sound when the disc 18 rotates. A plurality of comb teeth of the comb-shaped member have different lengths and are plucked by projections on the disc to create different notes of a scale. The disc 18 is rotated by receiving a force of a power spring, an electric motor (not shown), or the like.

As shown in FIG. 7 in detail, the box 16 is mainly formed of an upper horizontal sounding board 20, four side plates 22 surrounding four sides, and a lower bottom plate 24. The lid 14 is formed of a pair of doors 14a and 14b rotatably mounted to upper end portions of a pair of opposed side plates 22 through hinges 26. These doors 14a and 14b form a so-called double-door structure. The doors 14a and 14b cover the sounding board 20 and the sound producing mechanism 12 mounted on a central portion of an upper face of the sounding board 20 in a closed state as shown in FIG. 5. Substantially the whole doors 14a and 14b are in lower positions than the sound producing mechanism 12 as shown in FIG. 6 in an open state in which the doors 14a and 14b have rotated through 180° from positions in FIG. 5. Therefore, the lid 14 in a fully open state is not a hindrance in acoustical and physical terms. In other words, the sound produced by the sound producing mechanism 12 can spread sideways without being hindered by the doors 14a and 14b of the fully-open lid 14 and unnecessary reflection does not occur. With this structure, it becomes possible to mount a disc of a diameter greater than a lateral dimension of the box 16 to the sound producing mechanism 12. As a result, it is possible to set the lateral dimension of the box 16 at a smaller dimension than the diameter of the disc to thereby make the box 16 more compact than a prior-art box (see FIG. 7). The double doors 14a and 14b are advantageous as compared with a single door because the box 16 does not get out of weight balance when the doors 14a and 14b are open sideways. Also because opening of the doors requires less space, the double doors are advantageous as compared with the single door.

Respective members forming the box 16 are preferably made by using a solid fancy wood used for musical instruments for a purpose of producing beautiful sounds. As a coating, shellac varnish used for musical instruments such as violins, and especially highly-refined food shellac varnish is used preferably because it is possible to show colors of the wood as they are and to bring out beauty of the wood.

As is clear from the above description, according to the music box of the invention, because the sounding board and the bottom plate are fixed in close contact with the columns and the coupling members, the vibration of the music box is amplified by the sounding board and sound volume can be expanded in middle and lower registers even if an area of the sounding board or the bottom plate is small.

Furthermore, because the vibration is reliably transferred to the mount through the leg portions to cause the mount to cooperatively function as a sounding body, an effect of expanding the sound volume can be further obtained. Moreover, because the base frame of the movement of the music box and the sounding board, the bottom plate and the mount are disposed at a certain interval, vibrations of them do not hinder each other and the vibration transmission efficiency can be enhanced.

Although the embodiments of the music box according to the invention has been described above, the invention is not limited to the embodiments shown in the drawings and various modifications of details and changes such as restructuring of parts can be made with regard to a shape, a structure, and the like of the music box without departing from a scope of indispensable constituent features of the invention.

What is claimed is:

1. A music box, wherein a box is formed of a plurality of side plates, a sounding board mounted in vicinities of upper ends of the side plates, a bottom plate mounted in vicinities of lower ends of the side plates, and at least three columns sandwiched between the sounding board and the bottom plate and a sound producing body base frame is mounted on the sounding board of the box and fixed to the columns integrally with the sounding board by coupling members at least three positions through a spacer of a proper height.

2. A music box according to claim 1, wherein leg portions of proper heights and bottom areas are disposed in positions of a lower face of the bottom plate corresponding to portions where the columns are extending and are integrally fixed with the bottom plate to the columns by coupling members passing through the bottom plate.

3. A music box according to claim 1 or 2, wherein the sound producing body is a movement of a cylinder-type music box.

4. A music box according to claim 1 or 2, wherein the sound producing body is a movement of a disc-type music box.

5. A music box according to claim 1 or 2, wherein the box and the leg portions are made of a close-grained wood.

6. A music box according to claim 1, wherein material which produces nice sound effects is used for the sounding board.

7. A music box according to claim 1, wherein the columns are formed to function as members for applying internal stress to the sounding board.

8. A music box according to claim 1, wherein headed screw bodies are used as the coupling members, positions of the sound producing body base frame where the frame is to be fixed by the coupling members are aligned with positions of the columns, the screw bodies are screwed into the columns, and the sound producing body base frame, the spacer, and the sounding board are fixed while being integrally sandwiched between head portions of the screw bodies and the columns.
